(19) United States
(12) Patent Application Publication
(10) Pub. No.: US 2015/0122949 A1
(43) Pub. Date: May 7, 2015

(54) HYDRO-PNEUMATIC EJECTION ASSEMBLY FOR AN AIRCRAFT

(71) Applicant: ALKAN, Valentone (FR)

(72) Inventor: Alain Thevenot, Palaiseau (FR)

(21) Appl. No.: 14/584,129

(22) Filed: Dec. 29, 2014

Related U.S. Application Data
(63) Continuation of application No. PCT/FR2012/051629, filed on Jul. 10, 2012.

(51) Int. Cl. B64D 1/12

(52) U.S. Cl. CPC B64D 1/12
USPC 244/137.4

(57) ABSTRACT

Device for engaging and ejecting a load suspended below an aircraft, comprising at least two ejection pistons (4, 5) which are connected, on the one hand, to the load to be engaged/ejected and, on the other hand, to a control circuit (1) which comprises a pneumatic circuit (2, 3, 8), further comprising for supplying each ejection piston (4, 5) a hydraulic circuit (6, 7, 41, 51) which is interposed between the pneumatic circuit and the ejection pistons (4, 5).

### BACKGROUND

1. Field of the Invention

The present invention relates to a device for engaging and ejecting a load suspended below an aircraft, comprising at least two ejection pistons which are connected, on the one hand, to the load to be supported/ejected and, on the other hand, to a control circuit which comprises a pneumatic circuit.

2. Description of the Related Art

Currently, the ejection of a load from an aircraft is carried out using an ejector whose motor energy is either pyrotechnical or pneumatic. Such an ejector is provided with two pistons which apply to a released load a vertical force which is orientated in a downward direction and which is intended to distance the load from the aircraft in the most rapid manner possible.

The device has two main functions:
maintaining the load in a pretensioned state against the aircraft, during all the phases of the flight prior to the ejection,
releasing, then ejecting the load.

The motor energy, which is pyrotechnical or pneumatic in origin, is used to release the load then to supply the two ejection pistons. This energy is released in one step, then is distributed between the ejection pistons, using a ball valve, for example, a gas ball valve. This ball valve, which is a mechanical device which has been adjusted beforehand, allows the flow of gas which is conveyed to each ejection piston to be controlled. This flow is independent of the attitude of the aircraft, the aerodynamic forces which are applied to the ejected load and the dispersions of real mechanical characteristics of the load (mass, position at the center of gravity, etcetera) at the time of the ejection.

The ejection of modern loads, which are intended for precision strikes, requires better control of the position and the actual attitude of the load at the end of ejection.

Furthermore, the lighter constitution of aircraft and loads of this type than in the past requires that the release of motor energy toward the pistons be optimized over time in order to limit the reaction forces brought about.

Furthermore, a disadvantage of existing devices is not to control with sufficient precision the movement of each of the ejection pistons, in particular when they are relatively spaced apart from each other, and that they may be subjected to different loads.

There is consequently an occurrence of imprecision, when the load is released, with respect to the output speed of each ejection piston, which may present a problem for modern loads whose release requires precise initial conditions.

An object of the present invention is to overcome these disadvantages.

### SUMMARY OF THE INVENTION

The device according to the invention further comprises, for supplying each ejection piston, a hydraulic circuit which is interposed between the pneumatic circuit and the ejection pistons.

In this manner, the hydropneumatic ejector according to the invention, as a result of the use of a hydraulic fluid during the ejection phase, ensures unequalled operating performance levels:

Vertical speed at the end of ejection:
which is the highest possible in order to ensure a good separation trajectory at the released load,
and which is independent of the ambient temperature in order to cover the widest range of installation or flight conditions.

Angular pitch speed:
with finer adjustment,
being precise and independent of the aerodynamic reactions applied to the load.

The ejector according to the invention also allows the ejection pistons to be moved away from each other, and therefore allows the selection of contact surfaces with the load to be optimized in the aircraft.

According to another feature of the invention, the pneumatic circuit comprises a compressed gas store which is provided with a launch device having an electrovalve, more specifically the gas is a neutral gas, in particular nitrogen.

Advantageously, the hydraulic circuit comprises a dividing hydropneumatic transmitter which has a return spring interposed between the ejection pistons and the compressed gas store of the pneumatic circuit and which is responsible for distributing the hydraulic fluid to each ejection piston in a balanced manner.

According to an embodiment, the hydraulic circuit further comprises a fluid tank which is provided with a tank spring, a control valve which is provided with an adjustable spring, a distribution ball valve for hydraulic fluid and two threshold valves which are each provided with a return spring.

According to another embodiment, the pneumatic circuit further comprises a ball valve, a 3/2 distributor, a sequence valve, two non-return valves, a tank for retracting the ejection pistons, an unlocking piston and the compressed gas store.

Finally, according to another embodiment, the ejection pistons are of the single-action type.

### BRIEF DESCRIPTION OF THE DRAWING

FIG. 1 is a schematic diagram of an embodiment of the invention.

### DETAILED DESCRIPTION

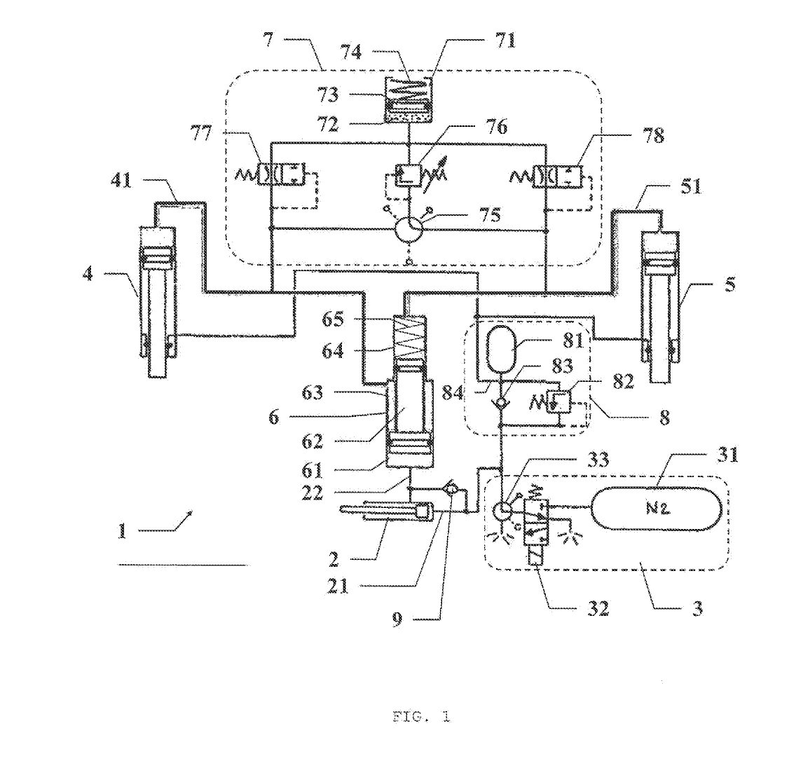

FIG. 1 has a control circuit 1. This control circuit 1 comprises an energy store 3 which, on the one hand, allows control of an unlocking piston 2 which firstly allows a load to be released until it is held against an aircraft and, on the other hand, allows control of at least two ejection pistons 4, 5 which secondly allow the load to be ejected.

The energy store 3 comprises a compressed gas store 31. This compressed gas store 31 is connected to the control circuit 1 using a distributor 32. In this instance, the distributor is a 3/2 distributor, which can be electrically controlled so as to move into a first position, which connects the store 31 to the control circuit 1 in order to allow the compressed gas contained in the store 31 to expand into the control circuit 1, and to be returned by a spring in the absence of electrical control into a second position which blocks the store 31 and which connects the control circuit 1 to the free air.

At the output of the distributor 32 there is arranged a ball valve 33 which allows the flow of compressed gas which enters the control circuit 1 to be controlled.

During control of the distributor 32, the compressed gas expands in the pneumatic circuit and supplies, on the one hand, a retraction module 8 described below and controls via the pipe 21 the unlocking piston 2. The pipe 21 is connected to a first chamber of the unlocking piston 2. When the unlocking piston 2 is moved, under the action of the gas pressure, a second chamber of the piston empties into a pipe 22.

This pipe 22 connects the second chamber of the piston 2 to a pneumatic chamber 61 of a dividing hydropneumatic transmitter 6. It is possible to note the presence of a non-return valve 9 which prevents compressed gas from being introduced directly into the transmitter 6. This ensures sequencing of operations. The unlocking piston 2 is controlled, firstly, in order to release the load, then the transmitter 6 is controlled, secondly, in order to carry out the ejection of the load.

The dividing hydropneumatic transmitter 6 is a hydropneumatic device which comprises a component 62 which slides in a body and which comprises two pistons which are fixedly joined, in order to separate the body into a pneumatic chamber 61 and two hydraulic chambers 63 and 64. The transmitter 6 is called a divider in that it is shaped so that the volumes of the two hydraulic chambers 63, 64 are equal at all times. In this manner, an introduction of gas into the pneumatic chamber 61, which increases the volume of the pneumatic chamber 61, produces a movement of the component 62 which is accompanied by a simultaneous movement of the two pistons and a simultaneous reduction of the volumes of the two hydraulic chambers 63, 64.

The hydraulic chamber 63 is connected to the ejection piston 4 by means of a pipe 41. The hydraulic chamber 64 is connected to the ejection piston 5 using a pipe 51. In this manner, the introduction of gas into the transmitter 6 is accompanied by a simultaneous reflux of hydraulic fluid into the two pipes 41, 51, and produces an identical movement, in terms of amplitude and speed, of each of the ejection pistons 4, 5. The transmitter 6 further comprises a return means 65, for example, a spring which is arranged in the hydraulic chamber 65 and which allows opposing movement of the component 62 in the absence of gas pressure in the pneumatic chamber 61. This opposing movement controls a simultaneous movement of the ejection pistons 4, 5 in the opposite direction.

This occurs when the distributor 32 is no longer electrically controlled. In this instance, corresponding to the position of the distributor 32 illustrated, the pneumatic chamber 61 of the transmitter 6 is connected to the free air via the pipes 21 and 22 and the non-return valve 9 which allows passage. Under the action of the return means 65, the component 62 moves in the opposite direction and draws the hydraulic fluid into the two chambers 63, 64 which brings about a retraction of the ejection pistons 4, 5.

According to an embodiment, the control circuit 1 further comprises a balancing device 7. This balancing device is connected, on the one hand, to the circuit 41 which connects the hydraulic chamber 63 and the ejection piston 4 and, on the other hand, to the circuit 51 which connects the hydraulic chamber 64 and the ejection piston 5. In this manner, the device 7 can carry out a balancing operation between these two circuits 41 and 51.

To this end, the balancing device 7 comprises a mechano-hydraulic store 71. This store 71 comprises a tank 72 for hydraulic fluid of variable volume and a movable piston 73 which separates the hydraulic fluid from a return means 74 which may be, for example, mechanical or gaseous. The piston 73 can thus be moved under the contradictory action of the return means 74 and any pressure of hydraulic fluid.

A single opening of the tank 72 enables it to be connected to a hydraulic circuit in which it contributes to maintaining pressure.

The hydraulic circuit of the balancing device 7 further comprises two tapping branches which connect the store 71 to one of the circuits 41 and 51, respectively, each one via a threshold valve 77, 78. Each of these valves 77, 78 has a threshold in order to allow passage as long as the pressure originating from the circuit 41, 51 remains lower than that threshold, and to prevent passage when the pressure exceeds that threshold.

The hydraulic circuit of the balancing device 7 further comprises a 3-way ball valve 75. Two of these ways are each connected to one of the two tapping branches and thus to one of the circuits 41 and 51, respectively, whilst the third way is connected to the store 71, via a control valve 76. The control valve 76 is such that it is closed as long as the pressure originating from the third way of the ball valve 75 is less than a threshold and open when the pressure is greater than the threshold. The threshold can be controlled using an adjustable spring.

The adjustment of the position of the ball valve thus allows precise control of the balance between the two tapping branches and thus between the circuits 41 and 51 which control the ejection pistons 4, 5.

According to an optional embodiment, the control circuit 1 further comprises a retraction device 8. It has been described that the hydraulic circuit ensures retraction of the ejection pistons 4, 5. A device 8 may optionally support the retraction by means of a pneumatic action acting on a second chamber of each ejection piston 4, 5.

To this end, the device 8 comprises a store 81 for compressed gas, a sequence valve 82 and a non-return valve 83. When the store 31 of compressed gas is released, the retraction device 8 receives, in parallel with the unlocking piston 2, compressed gas. This compressed gas is stored in the tank 81 via the valve 83. The valve 83 prevents the compressed gas from returning into the pneumatic circuit toward the unlocking piston 2. The sequence valve 82 serves to delay the retraction effect at least for a first time period which corresponds to the ejection phase, during which the ejection pistons 4, 5 are hydraulically controlled in terms of ejection. Following a time period determined by the sequence valve 82, the compressed gas stored in the tank 81 is released to a pipe 84. This pipe 84 is divided into one pipe per ejection piston 4, 5, each of which is connected to a second chamber of each ejection piston 4, 5, respectively. The term second chamber is intended to refer in this instance to the chamber of the ejection piston which is not already connected to the hydraulic circuit 41, 51. This compressed gas thus activates each ejection piston in an opposite direction to that produced under the preceding hydraulic action.

In this manner, it is possible to construct a device according to the invention, without any device 8, in which case the ejection pistons 4, 5 may be single-action pistons. It is further possible to construct a device according to the invention with a retraction device 8 in which the ejection pistons 4, 5 are dual-action pistons, a first hydraulic chamber ensuring the ejection and being involved in the retraction, a second pneumatic chamber ensuring the retraction.

What is claimed is:

1. A device for engaging and ejecting a load suspended below an aircraft, comprising at least two ejection pistons (4, 5) that are connected, on the one hand, to the load to be engaged/ejected and, on the other hand, to a control circuit (1) that comprises a pneumatic circuit (2, 3, 8), wherein the control circuit (1) further comprises, for supplying each ejection piston (4, 5), a hydraulic circuit (6, 7, 41, 51) interposed between the pneumatic circuit and the ejection pistons (4, 5).

2. The device of claim 1, wherein the pneumatic circuit comprises a compressed gas store (31) provided with a launch device having an electrovalve (32).

3. The device of claim 2, wherein the gas is a neutral gas, preferably nitrogen.

4. The device of claim 2, wherein the hydraulic circuit comprises a dividing hydropneumatic transmitter (6) with a return spring interposed between the ejection pistons (4, 5) and the compressed gas store (31) of the pneumatic circuit and that is responsible for distributing the hydraulic fluid to each ejection piston (4, 5) in a balanced manner.

5. The device of claim 4, wherein the hydraulic circuit further comprises a hydraulic fluid tank (72) provided with a tank spring (74), a control valve (76) provided with an adjustable spring, a distribution ball valve (75) for hydraulic fluid and two threshold valves (77, 78) each of which is provided with a return spring.

6. The device of claim 4, wherein the pneumatic circuit further comprises a ball valve (33), a 3/2 distributor (32), a sequence valve (82), two non-return valves (9, 83), a tank (81) for retracting the ejection pistons (4, 5), an unlocking piston (2) and the compressed gas store (31).

7. The device of claim 1, wherein the ejection pistons (4, 5) are of the single-action type.
